(19) United States
(12) Patent Application Publication
(10) Pub. No.: US 2026/0279856 A1
(43) Pub. Date: Sep. 17, 2026

(54) HUMIDIFICATION SYSTEM AND FUEL CELL SYSTEM

(71) Applicant: HONDA MOTOR CO., LTD., TOKYO (JP)

(72) Inventors: Yuhei HORIUCHI, WAKO-SHI (JP); Yuhi KINOSHITA, WAKO-SHI (JP)

(21) Appl. No.: 19/563,492

(22) Filed: Mar. 11, 2026

(30) Foreign Application Priority Data
Mar. 13, 2025 (JP) 2025-039899

(51) Int. Cl. H01M 8/04119; H01M 8/04746

(52) U.S. Cl. CPC H01M 8/04149; H01M 8/04141; H01M 8/04776; H01M 2250/20

(57) ABSTRACT

A humidification system includes a membrane module configured to transfer water vapor of a wet gas to a dry gas between a plurality of permeable membranes configured to allow water vapor to pass through, wherein a drain passage configured to transfer condensed water at a dry gas outlet to a wet gas outlet is formed inside a housing configured to cover the periphery of a membrane module.

### CROSS-REFERENCE TO RELATED APPLICATIONS

This application is based upon and claims the benefit of priority from Japanese Patent Application No. 2025-039899 filed on Mar. 13, 2025, the contents of which are incorporated herein by reference.

### BACKGROUND OF THE INVENTION

### Field of the Invention

The present disclosure relates to a humidification system and a fuel cell system that supply a fuel cell with a humidified gas.

### Description of the Related Art

In recent years, there has been research and development on fuel cells that contribute to energy efficiency to ensure that more people have access to affordable, reliable, sustainable and modern energy.

In the fuel cell system, moisture is added to a cathode gas through a humidification system (JP 4418299 B2).

### SUMMARY OF THE INVENTION

When the fuel cell system is stopped in a low-temperature environment, there is a case that frozen water (ice) will adhere to critical parts inside a humidification system and thus the operation of the humidification system will be hindered when the fuel cell system is restarted.

In order to solve the above problem, the present application aims to prevent the operation failure of the humidification system and achieve good cathode gas supply even when the fuel cell is stopped in a low-temperature environment. Further, it contributes to energy efficiency.

The first aspect of the present disclosure is a humidification system includes a membrane module configured to impart moisture of a wet gas to a dry gas via a plurality of permeable membranes configured to allow water vapor to pass through, a housing configured to cover a periphery of the membrane module, a dry gas introducing portion connected to the housing and configured to introduce the dry gas into the membrane module, a dry gas discharging portion connected to the housing and configured to discharge the dry gas from the membrane module, a wet gas introducing portion provided in the housing and configured to introduce the wet gas into the membrane module, a wet gas discharging portion connected to the housing and discharge the wet gas from the membrane module, and a drain passage configured to allow the dry gas discharging portion and the wet gas discharging portion to communicate with each other and allow water formed by condensation at the dry gas discharging portion to flow into the wet gas discharging portion, wherein the drain passage is formed inside the housing.

The second aspect of the present disclosure is a humidification system comprising: a membrane module configured to impart moisture of a wet gas to a dry gas via a plurality of permeable membranes configured to allow water vapor to pass through, a housing configured to cover a periphery of the membrane module, a dry gas introducing portion connected to a first side surface of the housing and configured to introduce the dry gas into the membrane module, a dry gas discharging portion connected to a second side surface of the housing and configured to allow the dry gas to flow out of the membrane module, a wet gas introducing portion connected to an upper surface of the housing and configured to introduce the wet gas into the membrane module, a wet gas discharging portion connected to a lower surface of the housing and configured to allow the wet gas to flow out of the membrane module, and a first valve connected to the wet gas discharging portion, wherein the wet gas discharging portion has an inclined flow path being inclined upward from a lower side of the housing toward the second side surface, an upper portion of the wet gas discharging portion overlaps a side surface of the housing, and the first valve is connected to an upper end of the inclined flow path, and at least a part of the first valve overlaps the second side surface when viewed from the lateral direction.

A third aspect of the present disclosure is a fuel cell system comprising a fuel cell stack and the humidification system according to the first or second aspect, wherein the dry gas is a cathode gas supplied to the fuel cell stack and the wet gas is a cathode off-gas discharged from the fuel cell stack.

According to the first aspect, the heat quantity of the dry gas or wet gas passing through the inside of the housing is efficiently transferred to the drain passage, and thus the drain passage can be quickly thawed.

According to the second aspect, the first valve can be placed close to the housing having a large heat capacity, and thus the first valve does not easily cool down and freezing of the first valve can be prevented.

According to the third aspect, because the orifice or valves can be thawed by utilizing the heat of the cathode off-gas discharged from the fuel cell stack, a fuel cell system that can be smoothly started up in a low-temperature environment is realized.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell system according to an embodiment;

FIG. 2 is a cross-sectional view showing a humidification system of FIG. 1 and surrounding pipes and valves;

FIG. 3A is a front view of a housing accommodating a membrane module, and FIG. 3B is a schematic view of a part of a permeable membrane, the first flow path and the second flow path included in the membrane module;

FIG. 4A is an enlarged cross-sectional view of a drain passage, and FIG. 4B is an enlarged cross-sectional view showing a modified example of the drain passage;

FIG. 5 is a perspective view showing an opening position of an upper end portion of the drain passage in the housing; and

FIG. 6 is an enlarged cross-sectional view of a connection portion between a dry gas introducing portion and the housing.

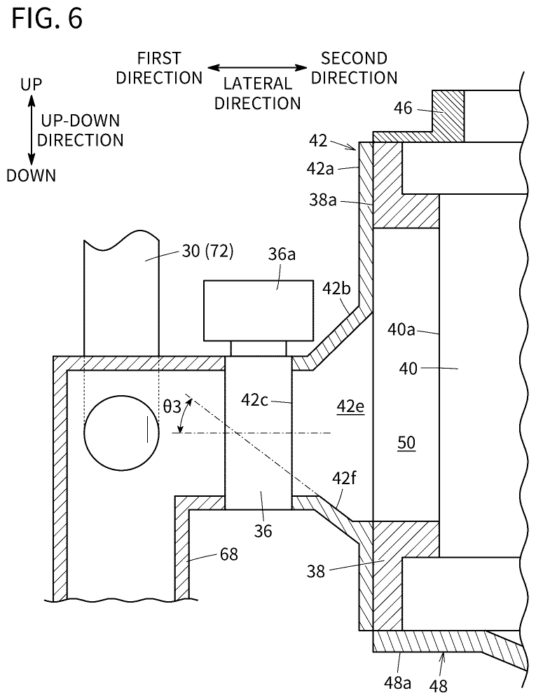

### DETAILED DESCRIPTION OF THE INVENTION

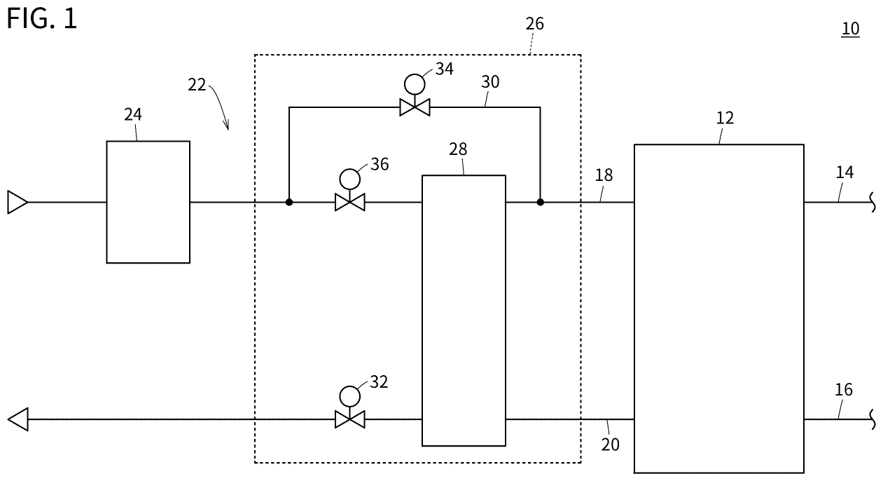

A fuel cell system 10 of the present embodiment shown in FIG. 1 includes a fuel cell stack 12 that generates electricity using air in the atmosphere as the cathode gas and hydrogen gas as the anode gas. The fuel cell system 10 is used, for example, to supply power for driving transportation equipment such as passenger cars, trucks, ships, and airplanes, or construction work equipment. The fuel cell system 10 can also be used as stationary power supply equipment for a facility such as a data center that uses electric power.

The fuel cell stack 12 includes a plurality of power generation cells in the interior thereof. One power generation cell includes an MEA in which a polymer electrolyte membrane is sandwiched between an anode and a cathode, and a pair of separators that sandwiches the MEA. The anode of each power generation cell is supplied with hydrogen as the anode gas whereas the cathode is supplied with air as the cathode gas.

The fuel cell system 10 is equipped with an anode supply flow path 14 for supplying the anode gas to the anode of the power generation cell of the fuel cell stack 12, an anode discharge flow path 16 for discharging an anode off-gas from the anode, and an anode accessory system for supplying the anode gas. In this specification, the illustration and description of the anode accessory system are omitted.

The fuel cell system 10 is equipped with a cathode supply flow path 18 for supplying the cathode gas to the cathode of the power generation cell of the fuel cell stack 12, a cathode discharge flow path 20 for discharging a cathode off-gas from the cathode, and a cathode accessory system 22. The cathode off-gas contains dry gas (air) that has not been used in the reaction at the fuel cell, and water vapor generated by the reaction between hydrogen and oxygen, and contains a relatively large amount of moisture. The cathode gas has relatively less moisture compared to the cathode off-gas and is therefore also referred to as dry gas in the following discussion. The cathode off-gas is also referred to as wet gas in the following description.

The cathode accessory system 22 includes a dry gas preparation unit 24 and a humidification system 26. The dry gas preparation unit 24 includes a compressor for boosting the pressure of the dry gas such as air, and a cooler for cooling the dry gas the temperature of which has been raised by the boosting of the pressure. The pressure-raised dry gas flows into the humidification system 26 through the cathode supply flow path 18. The humidification system 26 is connected to the cathode supply flow path 18 and the cathode discharge flow path 20 and supplies the water vapor contained in the wet gas to the dry gas to humidify the dry gas. The dry gas humidified by the humidification system 26 is supplied to the fuel cell stack 12 and used for power generation.

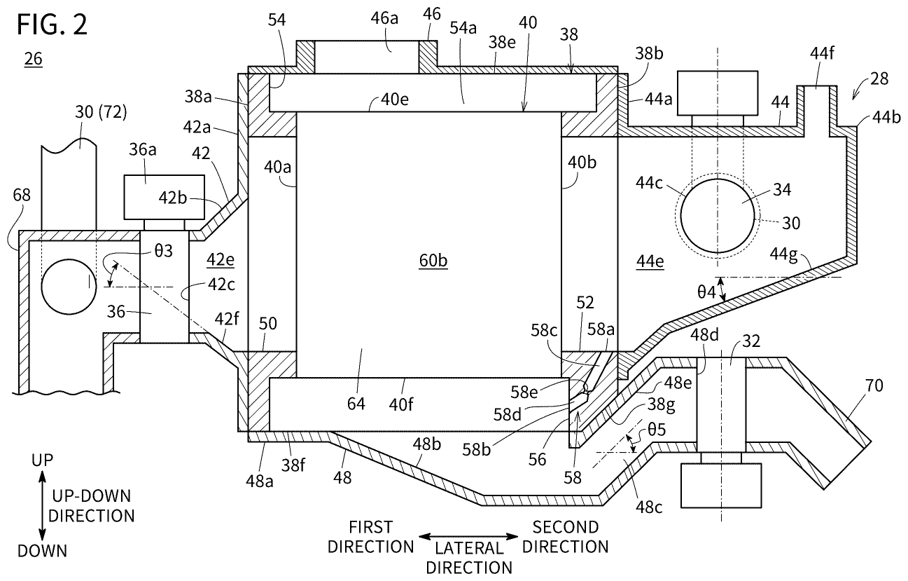

The humidification system 26 includes a humidification module 28, a bypass flow path 30, a first valve 32, a second valve 34, and a third valve 36. The humidification system 26 also includes a first pipe 68 forming part of the cathode supply flow path 18 and a second pipe 70 forming part of the cathode discharge flow path 20 (see FIG. 2).

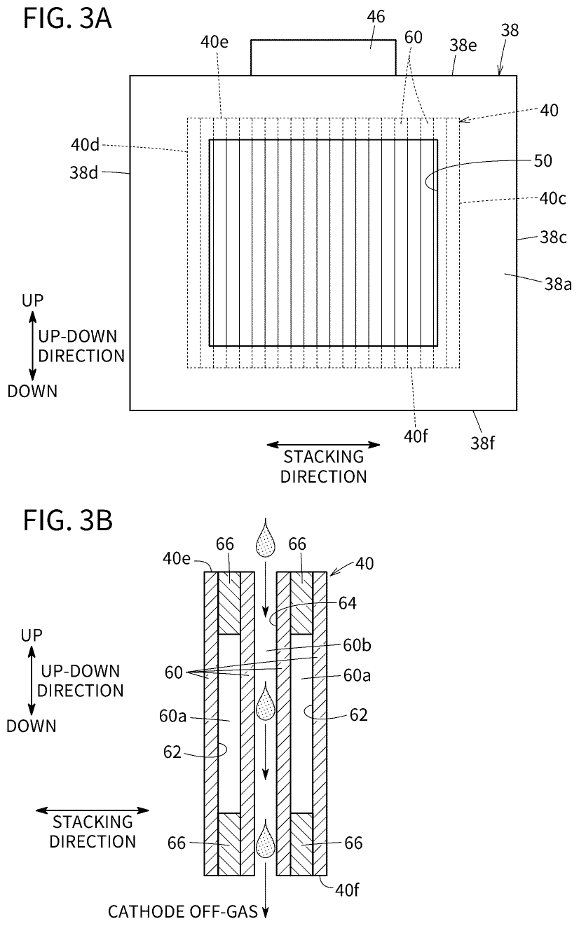

The humidification module 28 includes a housing 38, a membrane module 40, a dry gas introducing portion 42, a dry gas discharging portion 44, a wet gas introducing portion 46, and a wet gas discharging portion 48, as shown in FIGS. 2 and 3A. The housing 38 accommodates and supports the membrane module 40. The housing 38 is formed of a metal member such as an aluminum alloy, for example, and has a larger heat capacity and a relatively better thermal conductivity than the dry gas introducing portion 42, the dry gas discharging portion 44, the wet gas introducing portion 46, and the wet gas discharging portion 48.

In the following description, the terms lateral, stacking, and up-down directions are used to describe the arrangement relationship of the components of the humidification system 26. The lateral direction is the horizontal direction in a normal arrangement state of the humidification system 26 and is the direction parallel to a permeable membrane 60 of the membrane module 40. In the lateral direction, the direction from the center of the membrane module 40 toward the dry gas introducing portion 42 is called the first direction whereas the direction from the center of the membrane module 40 toward the dry gas discharging portion 44 is called the second direction.

The stacking direction is the horizontal direction in the normal arrangement state of the humidification system 26 and is the stacking direction of the permeable membrane 60 of the membrane module 40. The stacking direction is orthogonal to the lateral direction. The up-down direction is the vertical direction in the normal arrangement state of the humidification system 26 and is the direction orthogonal to the lateral direction and the stacking direction. The humidification system 26 mounted in the vehicle-mounted fuel cell system 10 could tilt depending on the parking location of the vehicle. In this case, the lateral and stacking directions do not always coincide with the horizontal direction, and the up-down direction does not coincide with the vertical direction.

The housing 38 is formed in a rectangular prism shape, and has a first side surface 38a, a second side surface 38b, a third side wall 38c, a fourth side wall 38d, an upper surface 38e, and a lower surface 38f. The first side surface 38a and the second side surface 38b are orthogonal to the lateral direction. The first side surface 38a is formed with a first opening 50. A first surface 40a of the membrane module 40 is exposed to the first opening 50. The dry gas flows into the membrane module 40 through the first opening 50.

The second side surface 38b is positioned opposite the first side surface 38a in the lateral direction (at an end portion in the second direction). The second side surface 38b is formed with a second opening 52. A second surface 40b of the membrane module 40 is exposed to the second opening 52. The second opening 52 allows the dry gas humidified by the membrane module 40 to flow out of the housing 38.

No opening is formed in the third side wall 38c and the fourth side wall 38d. The upper surface 38e is positioned at the upper end of the housing 38 and has a surface orthogonal to the up-down direction. The upper surface 38e is formed with a third opening 54. The third opening 54 exposes a part of the upper surface 40e of the membrane module 40. The third opening 54 communicates with an inlet space 54a formed in the upper surface 38e of the housing 38. The inlet space 54a communicates with each second flow path 64 of the membrane module 40. The wet gas is introduced into the second flow path 64 of the membrane module 40 through the third opening 54.

The lower surface 38f is positioned at the lower end of the housing 38 and has a surface orthogonal to the up-down direction. The lower surface 38f is formed with a fourth opening 56. The fourth opening 56 is formed in a rectangular shape and exposes the lower surface 40f of the membrane module 40. The wet gas that has passed through the membrane module 40 is discharged to the wet gas discharging portion 48 through the fourth opening 56.

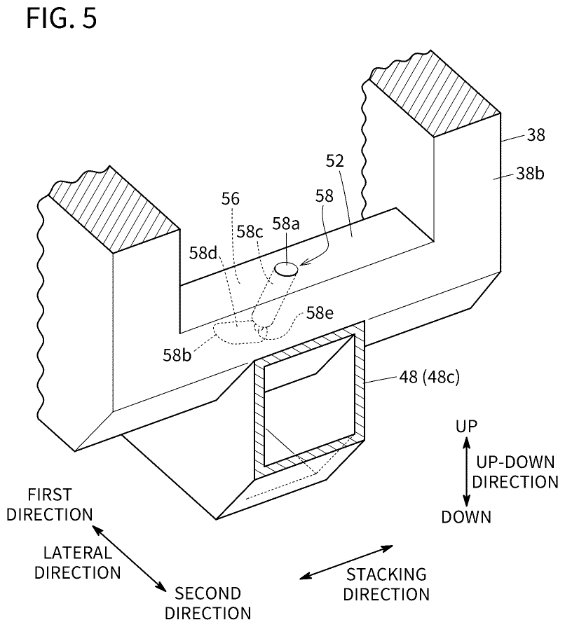

A drain passage 58 is formed at a connection portion between the second side surface 38b and the lower surface 38f in a lower portion of the housing 38. The drain passage 58 discharges the water formed by condensation at the dry gas discharging portion 44, which is the outlet of the humidified dry gas, to the wet gas discharging portion 48, which is the outlet of the wet gas. An upper end portion 58a of the drain passage 58 opens to the second opening 52 as shown in FIG. 5. The water formed by condensation at the dry gas discharging portion 44 can flow into the drain passage 58 from the upper end portion 58a. A lower end portion 58b of the drain passage 58 opens to the fourth opening 56. The lower end portion 58b is positioned above a water storage portion 48b of the wet gas discharging portion 48. Thus, the water discharged from the drain passage 58 can be guided to the water storage portion 48b, whereby the drainage performance is improved.

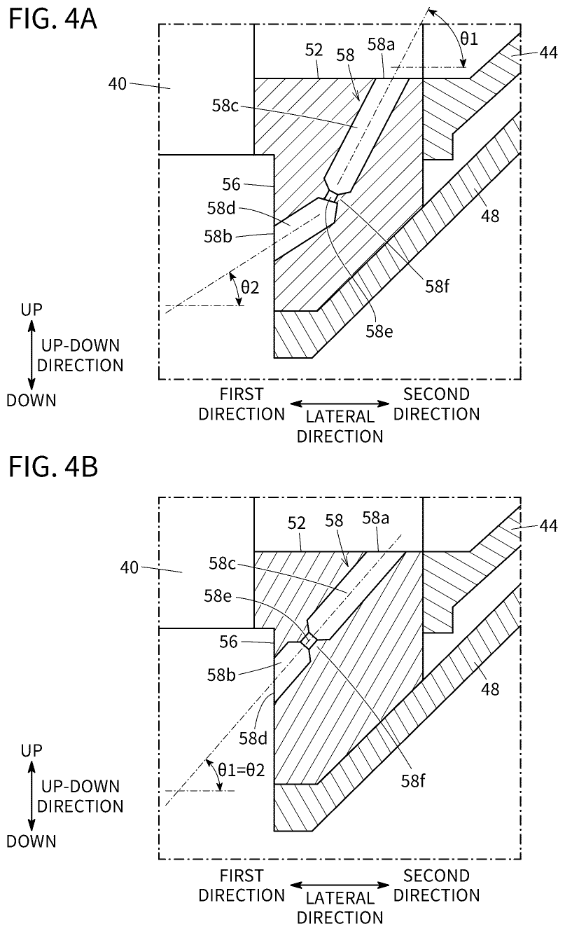

As shown in FIG. 4A, the drain passage 58 includes a first straight portion 58c, a second straight portion 58d, and an orifice 58e. The first straight portion 58c is a portion extending linearly from the upper end portion 58a of the drain passage 58. The second straight portion 58d is a portion extending linearly from the lower end portion 58b of the drain passage 58. The orifice 58e is formed in a bent portion 58f between the first straight portion 58c and the second straight portion 58d and allows the first straight portion 58c and the second straight portion 58d to communicate with each other. The first straight portion 58c and the second straight portion 58d have the same flow path cross-sectional area. The orifice 58e has a smaller flow path cross-sectional area than the first straight portion 58c and the second straight portion 58d. The orifice 58e prevents the leakage of the dry gas through the drain passage 58.

The drain passage 58 is generally inclined downward as it proceeds in the first direction of the lateral direction. The first inclination angle θ1 formed by the first straight portion 58c with respect to the second direction is larger than the second inclination angle θ2 formed by the second straight portion 58d with respect to the second direction. The first inclination angle θ1 and the second inclination angle θ2 are set, for example, to values larger than the maximum inclination angle of the vehicle (for example, 19° or more). The drain passage 58 like this can discharge the condensed water of the dry gas discharging portion 44 to the wet gas discharging portion 48 even when the vehicle is parked at an inclined place.

The drain passage 58 is made by forming each of the first straight portion 58c and the second straight portion 58d using a drill or the like having a predetermined diameter. The orifice 58e is formed at a connection portion between the first straight portion 58c and the second straight portion 58d. When the inner diameter of the orifice 58e is precisely controlled, the first drilling process is performed in such a way that the first straight portion 58c and the second straight portion 58d are not connected. The second drilling process is then performed to connect the first straight portion 58c and the second straight portion 58d with a drill having the diameter of the orifice 58e, which is smaller. Such a process allows for efficient formation of the drain passage 58 having the orifice 58e. The housing 38 may be formed by resin molding or the like and in this case, the drain passage 58 may be formed with the housing 38 by resin molding.

The drain passage 58 is not limited to the example in which the first inclination angle θ1 of the first straight portion 58c and the second inclination angle θ2 of the second straight portion 58d are different. For example, as shown in FIG. 4B, in the drain passage 58, the first inclination angle θ1 of the first straight portion 58c and the second inclination angle θ2 of the second straight portion 58d may be the same angle, and the first straight portion 58c and the second straight portion 58d may be aligned on the same axis.

The membrane module 40 includes a plurality of permeable membranes 60 stacked in the stacking direction as shown in FIGS. 2, 3A and 3B. Each of the permeable membranes 60 is formed of a material that allows water vapor to easily pass through. The membrane module 40 is formed in a rectangular prism shape as a whole by stacking a plurality of rectangular permeable membranes 60.

The membrane module 40 has the first surface 40a, the second surface 40b, a third surface 40c, a fourth surface 40d, the upper surface 40e, and the lower surface 40f. The first surface 40a is parallel to the up-down direction and orthogonal to the lateral direction and is a surface facing the first side surface 38a. The second surface 40b is parallel to the first surface 40a and is positioned opposite the first surface 40a in the lateral direction. The second surface 40b faces the second side surface 38b. The third surface 40c is orthogonal to the stacking direction and faces the third side wall 38c. The fourth surface 40d is orthogonal to the stacking direction and faces the fourth side wall 38d. The upper surface 40e is positioned at the upper end of the membrane module 40, is orthogonal to the up-down direction, and faces the upper surface 38e. The lower surface 40f faces the lower surface 38f of the membrane module 40.

The permeable membranes 60 are stacked apart from each other in the stacking direction and has a first gap 60a and a second gap 60b between the permeable membranes 60. The first gap 60a and the second gap 60b are adjacent to each other with the permeable membrane 60 interposed between them. The first gap 60a forms a first flow path 62 whereas the second gap 60b forms a second flow path 64.

A predetermined portion of a periphery portion of the permeable membrane 60 is sealed by a sealing member 66, whereby the flow direction of the first flow path 62 and the flow direction of the second flow path 64 are defined. The upper surface 40e and the lower surface 40f of the first flow path 62 are closed by the sealing member 66, and the first flow path 62 opens at the first surface 40a and the second surface 40b. The first flow path 62 communicates with the first opening 50 and the second opening 52 and allows the dry gas to flow from the first surface 40a toward the second surface 40b in the lateral direction.

The first surface 40a, the second surface 40b, the third surface 40c, and the fourth surface 40d of the second flow path 64 are closed by the sealing member 66, and the second flow path 64 opens at the upper surface 40e and the lower surface 40f. The second flow path 64 communicates with the third opening 54 and the fourth opening 56 and allows the wet gas to flow from the upper surface 40e toward the lower surface 40f in the up-down direction (downward). By making the wet gas flow downward, the water droplets contained in the wet gas are discharged without stagnating inside the membrane module 40. The water droplets discharged from the second flow path 64 are collected in the water storage portion 48b of the wet gas discharging portion 48 positioned below the membrane module 40.

The vicinity of the ridge line of the membrane module 40 is in air-tight contact with the housing 38, and the leakage of dry gas and wet gas through the gap between the membrane module 40 and the housing 38 is prevented.

The dry gas introducing portion 42 is a member for connecting the first pipe 68 located on the upstream side of the cathode supply flow path 18 to the humidification module 28 and is connected to the first side surface 38a of the housing 38. The dry gas introducing portion 42 has a first flange portion 42a contacting the first side surface 38a, and a first bulging portion 42b protruding a short distance from the first flange portion 42a in the first direction of the lateral direction. The first flange portion 42a is arranged to surround the periphery portion of the first bulging portion 42b and is brought into contact in an air-tight manner with the first side surface 38a with packing or the like. The first flange portion 42a is fixed to the housing 38 by a method such as fastening with bolts, adhesion with an adhesive, fusion bonding, welding, and so on. The first flange portion 42a may be formed by integral molding with the housing 38.

The first bulging portion 42b has a dry gas inlet 42c formed at an end portion in the first direction and also has a first connection flow path 42e inside. The first pipe 68 constituting a part of the cathode supply flow path 18 is connected to the dry gas inlet 42c via the third valve 36. The first connection flow path 42e allows the dry gas inlet 42c and the first opening 50 to communicate with each other. The first connection flow path 42e increases in diameter as it approaches the housing 38. The first bulging portion 42b has a dry-in inclined portion 42f at a lower portion. The dry-in inclined portion 42f is formed from the dry gas inlet 42c to the first opening 50 and is inclined downward as it approaches the housing 38.

The third inclination angle θ3 between the dry-in inclined portion 42f and the first direction of the lateral direction is preferably larger than the maximum inclination angle (for example, 19°) expected in the case of a vehicle or the like. By tilting the dry-in inclined portion 42f at the third inclination angle θ3, even when the vehicle stops at the inclined place and the operation of the fuel cell system 10 is stopped, it is possible to prevent freezing of the condensed water in the vicinity of the third valve 36.

The dry-in inclined portion 42f like this prevents the condensed water from staying in the vicinity of the third valve 36 by allowing the water droplets formed by condensation near the third valve 36 to flow out downward. The dry gas introducing portion 42 prevents the third valve 36 from malfunctioning due to freezing in a low-temperature environment.

The bulging length of the first bulging portion 42b in the lateral direction is set according to the size of a drive mechanism 36a of the third valve 36. The bulging length of the first bulging portion 42b is preferably formed as short as possible within a range that does not interfere with the first flange portion 42a and the like. Thus, the third valve 36 is arranged in the vicinity of the housing 38 having a large heat capacity, and the freezing of the condensed water at the third valve 36 can be effectively prevented.

As shown in FIG. 2, the dry gas discharging portion 44 is a member for connecting a pipe (not shown) located on the downstream side of the cathode supply flow path 18 to the humidification module 28 and is mounted to the second side surface 38b of the housing 38. The dry gas discharging portion 44 has a second flange portion 44a contacting the second side surface 38b, and a second bulging portion 44b protruding from the second flange portion 44a in the second direction of the lateral direction. The second flange portion 44a is arranged to surround a periphery portion of the second bulging portion 44b, and the gap between the second flange portion 44a and the second side surface 38b is sealed in an air-tight manner via packing or the like. The second flange portion 44a is fixed to the housing 38 by a method such as fastening with bolts, adhesion with an adhesive, fusion bonding, welding, and so on.

The second bulging portion 44b has a bypass outlet 44c, a second connection flow path 44e, and a dry gas outlet 44f to which a pipe located on the downstream side of the cathode supply flow path 18 is connected. The bypass outlet 44c is provided on a side portion in the stacking direction of the second bulging portion 44b. The second valve 34 is connected to the bypass outlet 44c. The bypass outlet 44c is connected to the bypass flow path 30 (bypass pipe 72) via the second valve 34. The bypass outlet 44c is located as close to the housing 38 as possible within a range where a drive portion of the second valve 34 does not interfere with the housing 38. The bypass outlet 44c is positioned above the lower surface 40f of the membrane module 40. When the bypass outlet 44c is placed at such a position, the occurrence of the opening/closing failure of the second valve 34 due to the freezing of the condensed water is suppressed.

The second connection flow path 44e is formed inside the second bulging portion 44b and allows the second opening 52, the bypass outlet 44c, and the dry gas outlet 44f to communicate with each other. A lower portion of the second connection flow path 44e is formed with a dry-out inclined portion 44g, which is inclined so as to be directed downward as the second bulging portion 44b approaches the housing 38. The lower end of the dry-out inclined portion 44g is connected to the second opening 52 of the housing 38. The dry-out inclined portion 44g like this smoothly guides the moisture condensed inside the second bulging portion 44b to the drain passage 58, thereby preventing the stagnation of the condensed water. The fourth inclination angle θ4 between the dry-out inclined portion 44g and the second direction is preferably larger than the maximum inclination angle (for example, 19°) expected in the case of the vehicle or the like.

The wet gas introducing portion 46 is positioned at an upper portion of the upper surface 38e of the housing 38 and protrudes a short distance upward. The wet gas introducing portion 46 is a member for connecting an upstream side pipe of the cathode discharge flow path 20 extending from the fuel cell stack 12 to the humidification module 28. A third connection flow path 46a formed inside the wet gas introducing portion 46 communicates with the inlet space 54a.

The wet gas discharging portion 48 is a member for connecting the second pipe 70 located on the downstream side of the cathode discharge flow path 20 to the humidification module 28. The wet gas discharging portion 48 is mounted to the lower surface 38f of the housing 38. The wet gas discharging portion 48 includes a fourth flange portion 48a contacting the lower surface 38f, the water storage portion 48b, an inclined flow path 48c, and a wet gas outlet 48d. The fourth flange portion 48a is arranged to surround a periphery portion of the water storage portion 48b and is in close contact with the lower surface 38f via packing or the like. The fourth flange portion 48a is fixed to the housing 38 by a method such as fastening with bolts, adhesion with an adhesive, fusion bonding, welding, and so on.

The water storage portion 48b is formed to bulge downward from the fourth flange portion 48a. The water storage portion 48b is positioned below the membrane module 40 and communicates with the second flow path 64. The water storage portion 48b stores condensed water contained in the wet gas flowing out from the second flow path 64. The water storage portion 48b is positioned below the lower end portion 58b of the drain passage 58 and stores condensed water flowing out of the drain passage 58. The water storage portion 48b has a volume that prevents water from overflowing even when water vapor present in a predetermined space including the humidification system 26 condenses.

The inclined flow path 48c extends from the water storage portion 48b toward the lower side of the dry gas discharging portion 44. The inclined flow path 48c is inclined upward from the water storage portion 48b toward the dry gas discharging portion 44. An inclined wall 48e inclined with respect to the lateral direction is formed on an upper part of the inclined flow path 48c. The inclined wall 48e is arranged to face at least a part of the dry-out inclined portion 44g of the dry gas discharging portion 44 with a slight gap. Thus, the first valve 32, which will be described later, is arranged in the vicinity of the housing 38, and freezing of the first valve 32 is suppressed. Such an arrangement can also reduce the size of the device configuration of the humidification system 26, thereby contributing to the miniaturization of the fuel cell system 10.

For example, the inclined flow path 48c may extend toward the lower side of the dry gas discharging portion 44. In this case, the inclined flow path 48c is inclined upward from the water storage portion 48b toward the dry gas discharging portion 44. The first valve 32 is connected to the upper end of the inclined flow path 48c, and at least a part of the first valve 32 may overlap a side portion of the dry gas discharging portion 44 when viewed from the lateral direction. At this time, when viewed from the lateral direction, the first valve 32 may at least partially overlap the second side surface 38b.

In order to arrange the inclined flow path 48c close to the dry gas discharging portion 44, the housing 38 has a notch 38g in the vicinity of the drain passage 58. The notch 38g is a portion formed by notching part of the housing 38 in the vicinity of the drain passage 58. The inclined flow path 48c passes through the notch 38g. The inclined wall 48e of the inclined flow path 48c is arranged to cover the notch 38g. The fifth inclination angle θ5 between the inclined flow path 48c and the second direction is preferably larger than the maximum inclination angle (for example, 19°) expected in the case of a vehicle or the like. By tilting the inclined flow path 48c at the fifth inclination angle θ5 like this, it is possible to prevent freezing in the vicinity of the first valve 32 even when the vehicle stops at an inclined place.

The wet gas outlet 48d is provided at the upper end of the inclined flow path 48c. The second pipe 70 located on the downstream side of the cathode discharge flow path 20 is connected to the wet gas outlet 48d via the first valve 32.

As shown in FIGS. 1 and 2, the bypass flow path 30 is a flow path that bypasses the membrane module 40 of the humidification module 28 and guides the dry gas to the dry gas discharging portion 44. As shown in FIG. 2, the bypass flow path 30 is constituted by the bypass pipe 72 that branches off and extends from the first pipe 68 of the humidification system 26. A downstream end of the bypass pipe 72 is connected to the dry gas discharging portion 44 via the second valve 34.

The second valve 34 is arranged at a position where the lower end of a portion exposed to the second connection flow path 44e is higher than the lower surface 40f of the membrane module 40. Thus, the stagnation of the condensed water in the vicinity of the second valve 34 is prevented. It is preferable to position the second valve 34 as close to the housing 38 as possible. As shown in FIG. 2, the second valve 34 is preferably provided at a position overlapping the first valve 32 when viewed from above. With this arrangement, the second valve 34 is also placed in the vicinity of the housing 38 having a large heat capacity and therefore, freezing of the second valve 34 can be prevented.

The humidification system 26 further includes the first pipe 68 and the second pipe 70. The first pipe 68 is connected to an upstream side of the dry gas introducing portion 42 and constitutes a part of the upstream of the cathode supply flow path 18. The third valve 36 is provided at a connection portion between the first pipe 68 and the dry gas introducing portion 42. The third valve 36 is a sealing valve capable of sealing the first pipe 68. The first pipe 68 has, in the vicinity of the third valve 36, a branch portion at which the bypass pipe 72 branches off.

The second pipe 70 is connected to the wet gas outlet 48d of the wet gas discharging portion 48 via the first valve 32. The second pipe 70 constitutes a part of a downstream side of the cathode discharge flow path 20 and discharges the wet gas that has passed through the humidification system 26.

The first valve 32 is positioned at a higher position than the water storage portion 48b. Thus, the wet gas can be guided to the first valve 32 without involving the condensed water of the water storage portion 48b. As a result, freezing of water in the vicinity of the first valve 32 is prevented.

At least a part of the first valve 32 is arranged to face the lateral direction of the second side surface 38b of the housing 38. Thus, the first valve 32 is less likely to cool, and the condensation of water at the first valve 32 can be more effectively suppressed.

The humidification system 26 of the present embodiment is configured as described above. The operation of the humidification system 26 will be described below.

When the operation of the fuel cell system 10 is stopped, the third valve 36, the second valve 34, and the first valve 32 in FIG. 2 are closed. The space on the cathode side of the fuel cell stack 12 is in communication with the humidification module 28 but is blocked from the outside by the third valve 36, and the second valve 34 and the first valve 32.

When time passes from the operation stop of the fuel cell system 10 in a low-temperature environment, the cooling of the humidification system 26 progresses and the temperature drop progresses from the dry gas introducing portion 42, the dry gas discharging portion 44, the wet gas introducing portion 46, the wet gas discharging portion 48, and the like, which have relatively small heat capacities. If these partial temperatures fall below the dew point temperature of the water vapor contained inside the humidification module 28, the water vapor condenses. The condensation of water vapor proceeds preferentially in a portion with lower temperature. The housing 38 with a large heat capacity is difficult to cool down and therefore has a relatively high temperature.

In the humidification system 26 of this embodiment, the first valve 32, the second valve 34, and the third valve 36 are arranged near the housing 38 having a large heat capacity. Therefore, the first valve 32, the second valve 34, and the third valve 36 do not cool down easily due to heat conduction, radiation, and the like from the housing 38 and thus condensation on the surfaces of these valves is suppressed.

If more time passes in the low-temperature environment, the temperature of the humidification system 26 will fall below the freezing temperature of the condensed water, and the condensed water will freeze. Even in this case, the first valve 32, the second valve 34, and the third valve 36 are prevented from freezing, and therefore, the valves can be smoothly driven in a low-temperature environment.

Since the drain passage 58 is formed inside the housing 38, a frozen state inside the housing 38 can be quickly turned into a thawed state by the heat of the high-temperature wet gas (cathode off-gas) flowing inside the housing 38 after the restart, and thus the drain passage 58 can be quickly opened. This prevents the humidification system 26 from malfunctioning.

With respect to the above embodiments, the following supplementary notes are further disclosed.

### Supplementary Note 1

A humidification system (26) includes a membrane module (40) configured to impart moisture of a wet gas to a dry gas via a plurality of permeable membranes (60) configured to allow water vapor to pass through, a housing (38) configured to cover a periphery of the membrane module, a dry gas introducing portion (42) connected to the housing and configured to introduce the dry gas into the membrane module, a dry gas discharging portion (44) connected to the housing and configured to discharge the dry gas from the membrane module, a wet gas introducing portion (46) provided in the housing and configured to introduce the wet gas into the membrane module, a wet gas discharging portion (48) connected to the housing and discharge the wet gas from the membrane module, and a drain passage (58) configured to allow the dry gas discharging portion and the wet gas discharging portion to communicate with each other and allow water formed by condensation at the dry gas discharging portion to flow into the wet gas discharging portion, wherein the drain passage is formed inside the housing.

In the above humidification system, since the drain passage is formed inside the housing having a large heat capacity, the heat of the wet gas is transmitted to the drain passage via the housing, and the frozen moisture in the drain passage can quickly melt. Thus, the drain passage can be quickly opened after the start of the system even under a low-temperature environment.

### Supplementary Note 2

In the humidification system according to Supplementary note 1, the housing may include a second opening (52) configured to open toward the dry gas discharging portion and a fourth opening (56) configured to open toward the wet gas discharging portion, wherein the drain passage may include an upper end portion (58a) exposed to the second opening of the housing and a lower end portion (58b) configured to open to the fourth opening of the housing. In this humidification system, since all the drain passage is formed in the housing, the heat of the wet gas can be transferred to the drain passage via the housing, and the drain passage can be quickly thawed.

### Supplementary Note 3

In the humidification system according to Supplementary note 2, the dry gas discharging portion may include a dry-out inclined portion (44g) configured to be inclined downward as the dry-out inclined portion approaches the housing, and the upper end portion of the drain passage may be provided at a position where water collected by the dry-out inclined portion flows in. This humidification system can smoothly discharge through the drain passage the condensed water generated in the dry gas discharging portion.

### Supplementary Note 4

In the humidification system according to Supplementary note 2 or 3, the wet gas discharging portion may include a fourth flange portion (48a) contacting the housing, a water storage portion (48b) bulging downward from the fourth flange portion, an inclined flow path (48c) extending upward at an angle from the water storage portion toward a lower side of the dry gas discharging portion, and a wet gas outlet (48d) extending from a upper end of the inclined flow path, wherein the water storage portion may be positioned below the lower end portion of the drain passage. This humidification system can lead the water discharged from the drain passage to the water storage portion, whereby the drainage performance improves.

### Supplementary Note 5

In the humidification system according to Supplementary note 2, the drain passage may include a first straight portion (58c) extending from the upper end portion, a second straight portion (58d) extending from the lower end portion, and a bent portion (58f) provided at a connection portion between the first straight portion and the second straight portion, wherein the bet portion may be formed with an orifice (58e) having a flow path cross-sectional area smaller than flow path cross-sectional area of the first straight portion and the second straight portion. This humidification system can ensure a drainage inclination in the drain passage, and ensure the drainage performance even if the humidification system is slightly inclined.

### Supplementary Note 6

A humidification system comprising: a membrane module configured to impart moisture of a wet gas to a dry gas via a plurality of permeable membranes configured to allow water vapor to pass through, a housing configured to cover a periphery of the membrane module, a dry gas introducing portion connected to a first side surface (38a) of the housing and configured to introduce the dry gas into the membrane module, a dry gas discharging portion connected to a second side surface (38b) of the housing and configured to allow the dry gas to flow out of the membrane module, a wet gas introducing portion connected to an upper surface (38e) of the housing and configured to introduce the wet gas into the membrane module, a wet gas discharging portion connected to a lower surface (38f) of the housing and configured to allow the wet gas to flow out of the membrane module, and a first valve (32) connected to the wet gas discharging portion, wherein the wet gas discharging portion has an inclined flow path being inclined upward from a lower side of the housing toward the second side surface, an upper portion of the wet gas discharging portion overlaps a side surface of the housing, and the first valve is connected to an upper end of the inclined flow path, and at least a part of the first valve overlaps the second side surface when viewed from the lateral direction.

In the above humidification system, the first valve connected to the inclined flow path of the wet gas discharging portion can be arranged close to the housing having a large heat capacity, and the first valve is not easily cooled by the heat of the housing, whereby the first valve can be prevented from freezing. In addition, the humidification system is miniaturized.

### Supplementary Note 7

In the humidification system according to Supplementary note 6, the wet gas discharging portion may include a water storage portion formed between a fourth opening provided in the lower surface of the housing and the first valve, the water storage portion may be provided further downward than the first valve, and the first valve may be arranged at a position overlapping the second side surface when viewed from the lateral direction. The humidification system can remove water droplets that may adhere to the first valve, by providing a water storage portion in the wet gas discharging portion. In addition, since the first valve is placed close to the housing having a large heat capacity, freezing of the first valve can be prevented more effectively.

### Supplementary Note 8

In the humidification system according to Supplementary note 7, the first valve may be connected to the upper end of the inclined flow path, and at least a part of the first valve may overlap a side portion of the dry gas discharging portion when viewed from the lateral direction. In this humidification system, since the second valve in addition to the first valve can be placed close to the housing having a large heat capacity, each valve does not cool easily, and freezing of the first and second valves can be prevented.

### Supplementary Note 9

In the humidification system according to Supplementary note 8, the dry gas discharging portion may include a dry-out inclined portion (44g) at a lower portion, the dry-out inclined portion being inclined downward as the dry-out inclined portion approaches the housing, the inclined flow path of the wet gas discharging portion may include an inclined wall (48e) at an upper portion, the inclined wall being inclined upward from the water storage portion toward the dry gas discharging portion, and the inclined wall may face at least a part of the dry-out inclined portion of the dry gas discharging portion. This humidification system can effectively prevent the first valve from freezing because the first valve can be placed close to the housing having a large heat capacity.

### Supplementary Note 10

In the humidification system according to Supplementary note 9, the dry gas introducing portion may include a dry-in inclined portion (42f) at a lower portion, the dry-in inclined portion being inclined downward from the first valve toward the housing. In this humidification system, the third valve provided at the inlet of the dry gas introducing portion can be placed close to the housing, and the third valve does not easily cool and thus freezing of the third valve can be prevented.

### Supplementary Note 11

In the humidification system according to Supplementary note 10, the dry gas may flow in the lateral direction through the first gap (60a) of the permeable membrane, the wet gas may flow in the up-down direction through the second gap (60b) of the permeable membrane, and the wet gas discharging portion may be positioned below the housing. Since the droplet in the second gap of the membrane module is discharged by gravity, this humidification system can prevent the breakage of the permeable membrane and the blockage of the second gap due to the growth of ice inside the membrane module.

### Supplementary Note 12

In the humidification system according to Supplementary note 11, the housing may have a larger heat capacity than the dry gas introducing portion, the dry gas discharging portion, the wet gas introducing portion, and the wet gas discharging portion. In this humidification system, since the second valve in addition to the first valve can be placed close to the housing having a large heat capacity, each valve does not cool easily, and freezing of the first and second valves can be prevented.

### Supplementary Note 13

A fuel cell system (10) of the present disclosure includes a fuel cell stack (12) and the humidification system according to any one of Supplementary notes 1 to 12, wherein the dry gas is a cathode gas supplied to the fuel cell stack, and the wet gas is a cathode off-gas discharged from the fuel cell stack. This fuel cell system can be smoothly started even under a low-temperature environment because the drain passage or the valve can be thawed by utilizing the heat of the wet gas heated by the fuel cell stack.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A humidification system comprising:
a membrane module configured to impart moisture of a wet gas to a dry gas via a plurality of permeable membranes configured to allow water vapor to pass through;
a housing configured to cover a periphery of the membrane module;
a dry gas introducing portion connected to the housing and configured to introduce the dry gas into the membrane module;
a dry gas discharging portion connected to the housing and configured to discharge the dry gas from the membrane module;
a wet gas introducing portion provided in the housing and configured to introduce the wet gas into the membrane module;
a wet gas discharging portion connected to the housing and configured to discharge the wet gas from the membrane module; and
a drain passage configured to allow the dry gas discharging portion and the wet gas discharging portion to communicate with each other and allow water formed by condensation at the dry gas discharging portion to flow into the wet gas discharging portion,
wherein the drain passage is formed inside the housing.

2. The humidification system according to claim 1, wherein
the housing includes
a second opening configured to open toward the dry gas discharging portion, and
a fourth opening configured to open toward the wet gas discharging portion,
wherein
the drain passage includes
an upper end portion configured to open toward the second opening of the housing, and
a lower end portion configured to open toward the fourth opening of the housing.

3. The humidification system according to claim 2, wherein
the dry gas discharging portion includes a dry-out inclined portion inclined downward as the dry-out inclined portion approaches the housing, and
the upper end portion of the drain passage is provided at a position where water collected by the dry-out inclined portion flows in.

4. The humidification system according to claim 2, wherein
the wet gas discharging portion includes
a fourth flange portion contacting the housing,
a water storage portion bulging downward from the fourth flange portion,
an inclined flow path extending upward at an angle from the water storage portion toward a lower side of the dry gas discharging portion, and
a wet gas outlet extending from an upper end of the inclined flow path, and
the water storage portion is positioned below the lower end portion of the drain passage.

5. The humidification system according to claim 2, wherein
the drain passage includes
a first straight portion extending from the upper end portion,
a second straight portion extending from the lower end portion, and
a bent portion provided at a connection portion between the first straight portion and the second straight portion, and
the bent portion is formed with an orifice having a flow path cross-sectional area smaller than flow path cross-sectional areas of the first straight portion and the second straight portion.

6. A humidification system comprising:
a membrane module configured to impart moisture of a wet gas to a dry gas via a plurality of permeable membranes configured to allow water vapor to pass through;
a housing configured to cover a periphery of the membrane module;
a dry gas introducing portion connected to a first side surface of the housing and configured to introduce the dry gas into the membrane module,
a dry gas discharging portion connected to a second side surface of the housing and configured to allow the dry gas to flow out of the membrane module,
a wet gas introducing portion connected to an upper surface of the housing and configured to introduce the wet gas into the membrane module,
a wet gas discharging portion connected to a lower surface of the housing and configured to allow the wet gas to flow out of the membrane module, and
a first valve connected to the wet gas discharging portion,
wherein
the wet gas discharging portion includes an inclined flow path being inclined upward from a lower side of the housing toward the second side surface, and an upper portion of the wet gas discharging portion overlaps a side surface of the housing, and
the first valve is connected to an upper end of the inclined flow path, and at least a part of the first valve overlaps the second side surface when viewed from a lateral direction.

7. The humidification system according to claim 6, wherein
the wet gas discharging portion includes a water storage portion formed between a fourth opening provided in the lower surface of the housing and the first valve,
the water storage portion is provided further downward than the first valve, and
the first valve is arranged at a position overlapping the second side surface when viewed from the lateral direction.

8. The humidification system according to claim 7, wherein
the first valve is connected to the upper end of the inclined flow path, and at least a part of the first valve overlaps a side portion of the dry gas discharging portion when viewed from the lateral direction.

9. The humidification system according to claim 8, wherein
the dry gas discharging portion includes a dry-out inclined portion at a lower portion, the dry-out inclined portion being inclined downward as dry-out inclined portion approaches the housing,
the inclined flow path of the wet gas discharging portion includes an inclined wall at an upper portion, the inclined wall being inclined upward from the water storage portion toward the dry gas discharging portion, and
the inclined wall faces at least a part of the dry-out inclined portion of the dry gas discharging portion.

10. The humidification system according to claim 9, wherein
the dry gas introducing portion includes a dry-in inclined portion at a lower portion, the dry-in inclined portion being inclined downward from the first valve toward the housing.

11. The humidification system according to claim 10, wherein the dry gas flows in the lateral direction through a first gap of the permeable membrane, the wet gas flows in an up-down direction through a second gap of the permeable membrane, and the wet gas discharging portion is positioned below the housing.

12. The humidification system according to claim 11, wherein the housing has a larger heat capacity than the dry gas introducing portion, the dry gas discharging portion, the wet gas introducing portion, and the wet gas discharging portion.

13. A fuel cell system comprising:
a fuel cell stack; and
the humidification system according to claim 1,
wherein the dry gas is a cathode gas supplied to the fuel cell stack, and
the wet gas is a cathode off-gas discharged from the fuel cell stack.
